(19) United States
(12) Patent Application Publication
(10) Pub. No.: US 2014/0181083 A1
(43) Pub. Date: Jun. 26, 2014

(54) METHOD AND APPARATUS FOR MULTI-DIMENSIONAL GRAPHICAL REPRESENTATION OF SEARCH QUERIES AND RESULTS

(71) Applicant: MOTOROLA SOLUTIONS, INC., Schaumburg, IL (US)

(72) Inventors: DUSAN MACHO, ARLINGTON HEIGHTS, IL (US); KENNETH W. DOUROS, SOUTH BARRINGTON, IL (US); SAMEER B. TOTEY, BOULDER, CO (US)

(73) Assignee: MOTOROLA SOLUTIONS, INC., SCHAUMBURG, IL (US)

(21) Appl. No.: 13/723,746

(22) Filed: Dec. 21, 2012

(51) Int. Cl. G06F 17/30; G06F 3/0481

(52) U.S. Cl. CPC G06F 17/3056; G06F 17/30991; G06F 3/04817
USPC 707/722; 707/769; 715/765

(57) ABSTRACT

A method and user terminal are provided that graphically formulate a search query. The method and user terminal display, via a display screen, a multi-dimensional graphical representation of a search query space, receive a plurality of parameters from a user, wherein the parameters define the search query space, position a multi-dimensional icon in the multi-dimensional representation of the search query space, associate one or more of a keyword and multimedia content with the icon, and generate a search query based on the keyword and the position of the icon in the multi-dimensional representation of the search query space. The method and user terminal further may graphically display the results of the corresponding database search, wherein the retrieved content is displayed as one or more icons positioned in a multi-dimensional graph having a plurality of axes associated with the plurality of parameters defining a context of the search query.

### FIELD OF THE INVENTION

The present invention relates generally to information aggregation systems and, in particular, to a method and apparatus for multi-dimensional graphical representation of queries and results.

### BACKGROUND OF THE INVENTION

Currently, browser-based queries are in either a text form, for example, “gunshot at Michigan and Jackson in Chicago,” or a multimedia file uploaded to a system for search.

### BRIEF DESCRIPTION OF THE DRAWINGS

FIG. 1 is a block diagram of an exemplary communication system in accordance with an embodiment of the present invention.

FIG. 2 is a block diagram of a user terminal in accordance with an embodiment of the present invention.

FIG. 3A is a logic flow diagram that illustrates a method performed by the user terminal of FIG. 1 in graphically formulating a search query in accordance with various embodiments of the present invention.

FIG. 3B is a continuation of the logic flow diagram of FIG. 3A illustrating a method performed by the user terminal of FIG. 1 in graphically formulating a search query in accordance with various embodiments of the present invention.

FIG. 4 is an exemplary multi-dimensional graphical representation of a search query that may be displayed on a display screen of the user terminal of FIG. 1 in accordance with an embodiment of the present invention.

FIG. 5 is an exemplary multi-dimensional graphical representation of a search query that may be displayed on a display screen of the user terminal of FIG. 1 in accordance with another embodiment of the present invention.

FIG. 6 is an exemplary multi-dimensional graphical representation of a search query that may be displayed on a display screen of the user terminal of FIG. 1 in accordance with another embodiment of the present invention.

FIG. 7 is a logic flow diagram that illustrates a method performed by the user terminal of FIG. 1 in graphically displaying search results in accordance with various embodiment of the present invention.

FIG. 8 is an exemplary multi-dimensional graphical representation of search results that may be displayed on a display screen of the user terminal of FIG. 1 in accordance with another embodiment of the present invention.

FIG. 9 is an exemplary multi-dimensional graphical representation of search results that may be displayed on a display screen of the user terminal of FIG. 1 in accordance with another embodiment of the present invention.

FIG. 10 is an exemplary multi-dimensional graphical representation of search results that may be displayed on a display screen of the user terminal of FIG. 1 in accordance with another embodiment of the present invention.

FIG. 11 is an exemplary diagram that illustrates a graphical representation of a search query displayed on a display screen of the user terminal of FIG. 1 in accordance with an embodiment of the present invention.

FIG. 12 is an exemplary diagram that illustrates a graphical representation of a search query and corresponding search results that are concurrently displayed on a display screen of the user terminal of FIG. 1 in accordance with an embodiment of the present invention.

FIG. 13 is an exemplary diagram that illustrates a graphical representation of a search query and corresponding search results that are concurrently displayed on a display screen of the user terminal of FIG. 1 in accordance with another embodiment of the present invention.

FIG. 14 is an exemplary diagram that illustrates a graphical representation of a search results that are displayed on a display screen of the user terminal of FIG. 1 in accordance with another embodiment of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

A method and user terminal are provided that graphically formulate a search query. The method and user terminal display, via a display screen, a multi-dimensional graphical representation of a search query space, receive, via a user interface of the user terminal, a plurality of parameters from a user, wherein the parameters define the search query space, position a multi-dimensional icon in the multi-dimensional representation of the search query space, associate one or more of a keyword and multimedia content with the icon, and generate a search query based on the keyword and the position of the icon in the multi-dimensional representation of the search query space. The method and user terminal further may graphically display the results of the corresponding database search, wherein the retrieved content is displayed as one or more icons positioned in a multi-dimensional graph having a plurality of axes associated with the plurality of parameters defining a context of the search query.

Generally, an embodiment of the present invention encompasses a method for graphically formulating a search query. The method includes displaying a multi-dimensional graphical representation of a search query space, receiving a plurality of parameters from a user, wherein the parameters define the search query space, positioning and sizing a multi-dimensional icon in the multi-dimensional representation of the search query space, associating one or more of a keyword and multimedia content with the icon, and generating a search query based on the one or more of the keyword and multimedia content, and the position and size of the icon in the multi-dimensional representation of the search query space.

Another embodiment of the present invention encompasses a method for graphically displaying results of a database search. The method includes retrieving search-related multi-media content from one or more databases based on a search query and displaying the search results in a multi-dimensional graphical format on a display screen, wherein the retrieved multimedia content is displayed as one or more icons positioned in a multi-dimensional graph having a plurality of axes, wherein each axis of the plurality of axes is associated with a parameter of the plurality of parameters defining a context of the search query, and wherein a relationship among search results is indicated.

Yet another embodiment of the present invention encompasses a user terminal that includes a user interface comprising a display screen. The user terminal further includes a processor that is configured to display, via the display screen, a multi-dimensional graphical representation of a search query space, receive, via the user interface, a plurality of parameters from a user, wherein the parameters define the search query space, position and size a multi-dimensional icon in the multi-dimensional representation of the search query space, associate one or more of a keyword and multimedia content with the icon, and generate a search query based on the one or more of the keyword and multimedia content, and the position and size of the icon in the multi-dimensional representation of the search query space.

Still another embodiment of the present invention encompasses a user terminal for graphically displaying results of a database search. The user terminal includes a display screen and a processor that is configured to retrieve search-related multi-media content from one or more databases based on a search query and display, via the display screen, the search results in a multi-dimensional graphical format on a display screen, wherein the retrieved multi-media content is displayed as one or more icons positioned in a multi-dimensional graph having a plurality of axes, wherein each axis of the plurality of axes is associated with a parameter of the plurality of parameters defining a context of the search query, and wherein a relationship among search results is indicated.

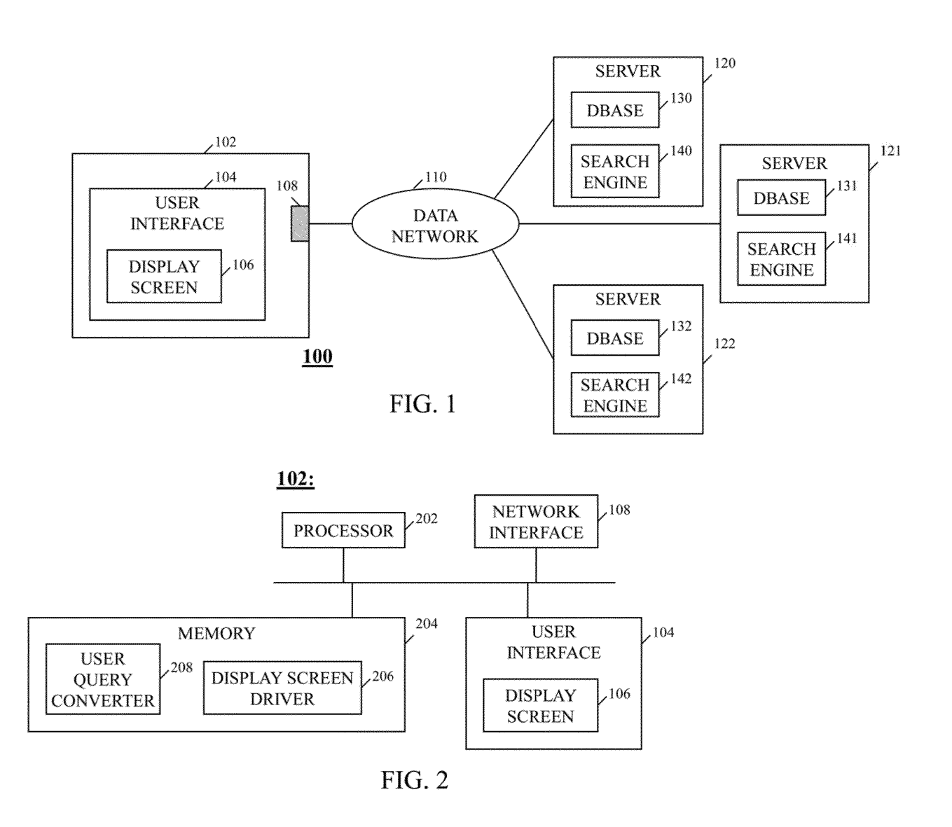

Turning now to the drawings, the present invention may be more fully described with reference to FIGS. 1-14. FIG. 1 is a block diagram of an exemplary communication system 100 in accordance with an embodiment of the present invention. Communication system 100 includes a user terminal 102 that is connected to multiple servers 120-123 (three shown) via a data network 110. Data network 110 may comprise, for example, a wide area network (WAN), a local area network (LAN), a telephone network such as a Public Switched Telephone Network (PSTN), the Internet, a privately operated data network such as an enterprise network, a wireless network such as a cellular network or a Wireless LAN (WLAN), a Public Safety network, or a combination of networks.

User terminal 102 may be any kind of user device into which a user may enter a data query and which includes a display for displaying results of that query. More particularly, user terminal 102 includes a user interface 104 via which a user may input a search query into the user terminal, and a display screen 106 for displaying the search query and results of a corresponding search. For example, user terminal 102 may be a wireless mobile device, such as a cellular telephone, a radio telephone, a smart phone, or a personal digital assistant (PDA) with radio frequency (RF) capabilities, may be a personal computer, a laptop computer, or a tablet computer with or without radio frequency (RF) capabilities, or may be a communication console, such as used in a computer-assisted dispatch (CAD) system, for example, a Public Safety and enterprise system. User terminal further includes a network interface 108, for example, a wireless, wireline, or optical interface, for connecting to data network 110.

Servers 120-122 each includes a respective database 130-132 that may be searched by user terminal 102. More particular, servers 120-122 each includes a server entity that may collect, process, and maintain data in the corresponding database 130-132 and further includes a respective search engine 140-142 that may search the database, or other databases that may be internal or external to the server, in response to receiving a query from user terminal 102. In other embodiments of the present invention, one or more of search engines 140-142 may be external to, and in communication with, a corresponding server 120-122. Servers 120-122 each may be connected to data network 110 via any of a wireless, wireline, or optical connection, or any other connection known in the art. Databases 130-132 maintain multimedia content, such as video recordings, audio recordings, emails, tweets, and/or any other social media, such as Facebook© entries. Further, it is assumed herein that multimedia content stored in databases 120-122 is stored in association with one or more of: one or more content-defining parameters, one or more keywords, and one or more keyword modifiers, as described in greater detail below, and can be retrieved by searching for those parameters/keywords/keyword modifiers.

Referring now to FIG. 2, a block diagram is depicted of user terminal 102 in accordance with various embodiments of the present invention. User terminal 102 includes a processor 202, such as one or more microprocessors, microcontrollers, digital signal processors (DSPs), combinations thereof or such other devices known to those having ordinary skill in the art. The particular operations/functions of processor 202, and thus of user terminal 102, is determined by an execution of software instructions and routines that are stored in a respective at least one memory device 204 associated with the processor, such as random access memory (RAM), dynamic random access memory (DRAM), and/or read only memory (ROM) or equivalents thereof, that store data and programs that may be executed by the corresponding processor. However, one of ordinary skill in the art realizes that the operations/functions of processor 202 alternatively may be implemented in hardware, for example, integrated circuits (ICs), application specific integrated circuits (ASICs), a programmable logic device such as a PLD, PLA, FPGA or PAL, and the like, implemented in the user computer device. Based on the present disclosure, one skilled in the art will be readily capable of producing and implementing such software and/or hardware without undo experimentation.

User terminal 102 further includes user interface 104 and network interface 108, which user interface and network interface are each coupled to processor 202. As described above, network interface 108 may be a wireless, wireline, or optical interface capable of conveying messaging, such as data packets, to, and receiving messaging from, data network 110. User interface 104 includes display screen 106, which display screen may or may not comprise a capacitive touchscreen, and further may include a keypad, buttons, a touch pad, a joystick, a mouse, an additional display, or any other device useful for providing an interface between a user and an electronic device such as user terminal 102 and via which the user may input instructions into the user terminal. For example, the user may select an icon displayed on display screen 106, as described in greater detail below, by touching the icon on the touchscreen or by selecting the icon by use of the mouse. By way of another example, the user may input text in an icon or label an axis of a graph displayed on display screen 106 by selecting the icon or axis and then entering text into the icon/axis via the keyboard. Display screen 106 may be a liquid crystal display (LCD), a light emitting diode (LED) display, a plasma display, or any other means for visually displaying information.

At least one memory device 204 includes a display screen driver 206 that is executed by processor 202. Display screen driver 206 comprises data and programs that control an operation of display screen 106, for example, for providing a multi-dimensional graphical representation on the display screen in response to user inputs. Further, when display screen 106 comprises a touchscreen, display screen driver 206 comprises data and programs for sensing a capacitive change in the touchscreen and determining a location of a user's touch on the touchscreen.

At least one memory device 204 further includes a multidimensional graphical user interface (GUI) user query converter 208, that when executed by processor 202, converts a user's graphical query into a machine readable format for execution by a search engine, such as search engines 140-142 and that converts text received in response to a search to graphical information (text-to-graph conversion) for display on display screen 106. More particularly, display screen driver 206 is configured such that a user of user terminal 102 may enter a search query in a graphical form, that is, by manipulating an icon in a multi-dimensional graphical representation depicted on display screen 106, wherein each dimension, or axis, of the graphical representation corresponds to a parameter to be searched, such as time and location of an event, which query then is converted by the display screen driver to an instruction that is converted to searchable code by user query converter 208. Similarly, display screen driver 206 then may present the results of the search in a multi-dimensional graphical representation on display screen 106, again, for example, wherein each dimension, or axis, of the graphical representation corresponds to a searched parameter.

In other words, communication system 100, and in particular user terminal 102, provides a user of the user terminal with a multimedia query system comprising a multi-dimensional graphical query and result representation. More particularly, user terminal 102 allows the user to input a search query into the user terminal by positioning an icon in a multi-dimensional graph that is displayed on display screen 106, wherein the different dimensions, or axes, of the graph correspond to different parameters of the query, such as location and time, thereby allowing the user to use the positioning of the icon to input the parameters of the query. Further, the user can input text into the icon, thereby inputting one or more keywords and associated parameters to be searched. Furthermore, the user can upload multimedia files into the icon to provide additional search parameters; multimedia files can be indexed to facilitate the search.

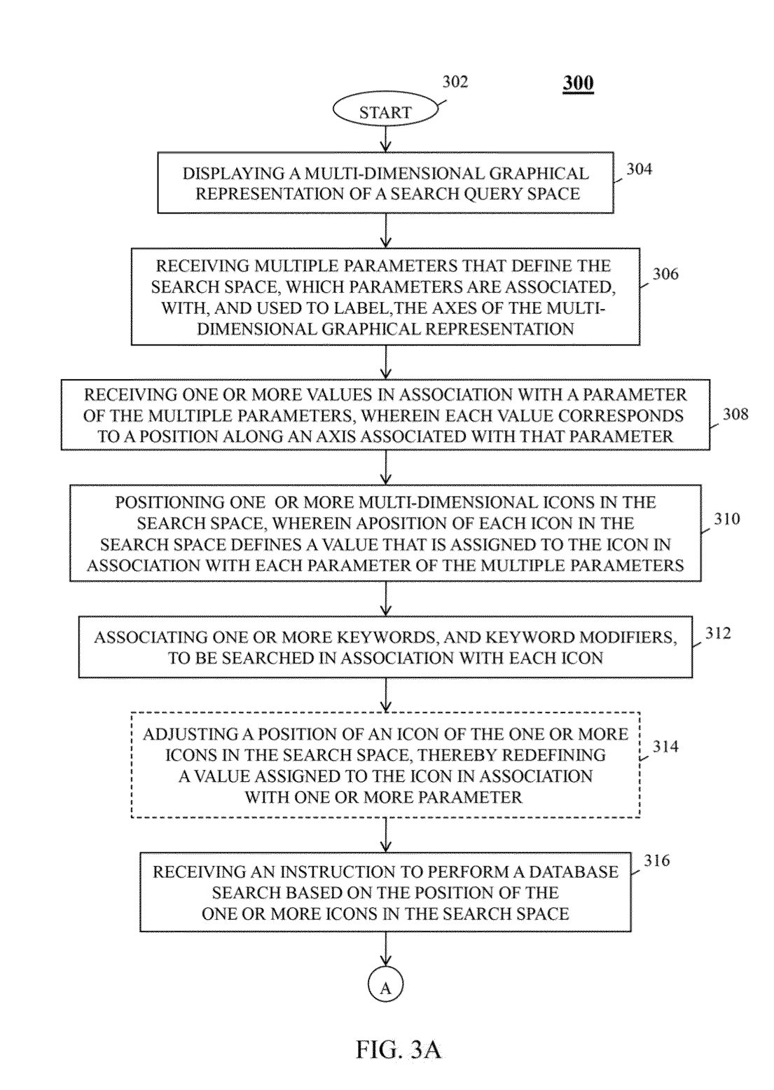

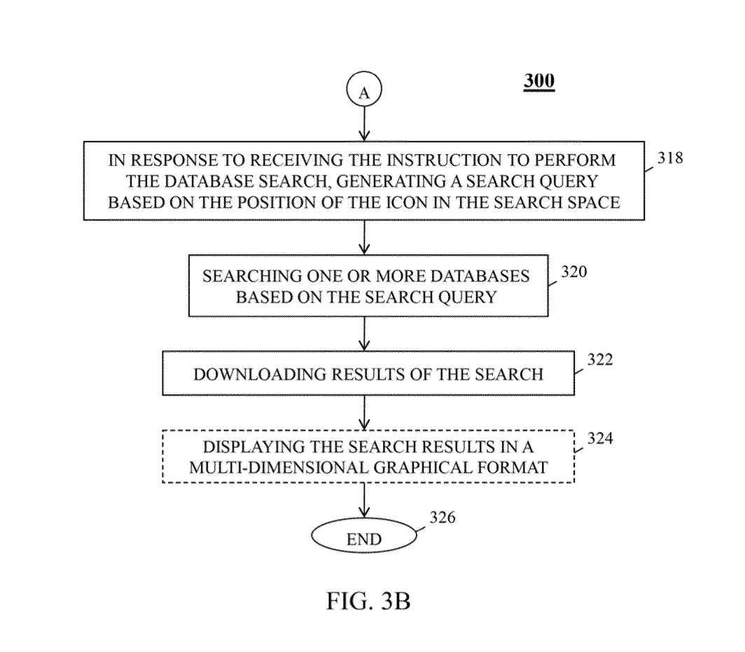

For example, and referring now to FIGS. 3-6, an exemplary two-dimensional graphical formulation of a search query is illustrated in accordance with an embodiment of the present invention. FIGS. 3A and 3B depict a logic flow diagram 300 that illustrates a method performed by user terminal 102 in graphically formulating a search query in accordance with an embodiment of the present invention. Logic flow diagram 300 begins (302) when user terminal 102 displays (304), on display screen 106, a multi-dimensional graphical representation of a search query space. More particularly, the multi-dimensional graphical representation comprises a multi-dimensional graph wherein each dimension, or axis, of the multi-dimensional graph represents a parameter defining a context of content to be searched. Multiple parameters, corresponding to the multiple dimensions, defining the context of the content then are input by the user and received (306) by the user terminal, wherein each parameter may be associated with a dimension, or axis, of the multi-dimensional graphical representation of the search query space. User terminal 102 then uses the multiple parameters to define the search space, for example, to label each axis of the search space, or graph, wherein each axis of multiple axes of the multi-dimensional graphical representation of the search query space is associated with, and correspondingly labeled by, a parameter of the multiple parameters. For example, the content may be various media, such as video, audio recordings, email, tweets, and other social media associated with an occurrence of an event, and the axes of the graph may represent parameters defining the occurrence of the event, for example, time and location.

The user then may input, and user terminal 102 receive (308), one or more values, or instances, associated with each of one or more parameters (that is, the parameters corresponding to each axis of the graphical representation). Each such value received with respect to a parameter may correspond to a position along the axis associated with that parameter. The user terminal then may label the corresponding positions along with corresponding axis using the provided values. The user then may input, and user terminal 102 receive (310), the values to be used in the search query by positioning a multi-dimensional icon in the multi-dimensional search space, wherein the position of the icon corresponds to a value assigned to the icon in association with each of the multiple parameters corresponding to the multiple axes of the search space. For example, the user may specifically label discrete values along one or more of the axes. In addition, the user may input one or more keywords and, optionally, keyword modifiers and multimedia content or files, that the user terminal then associates (312) with each icon. For example, the user may input text and/or upload multimedia content or files into each icon, which text may comprise one or more keywords, and associated keyword modifiers, to be searched and which multimedia content/files provide additional search parameters—multimedia files can be indexed to facilitate the search.

Further, a user may adjust (314) a position of an icon, that is, input an instruction to adjust a position of an icon, in response to which user terminal 102 adjusts the position of the icon and, by repositioning the icon in the search space, or graph, adjusts one or more values of a parameter associated with an icon, thereby redefining a value assigned to the icon in association with the parameter, when generating the search query. For example, with reference to FIG. 6 below, if an icon 602 is repositioned from a location labeled “Wabash/Adams” (location′ being a parameter associated with the vertical axis of the search space) to a location labeled “Michigan/Jackson,” then a keyword(s) searched with respect to icon 602, that is, a car tire screech, would be searched with respect to the location “Michigan/Jackson” instead of the location “Wabash/Adams.”

After inputting his or her search query, comprising the parameters defining the speech space, a positioning of an icon in the search space, and an associating of one or more keywords and keyword modifiers associated with the icon, the user of user terminal 102 then may instruct the user terminal to perform (316) a database search associated with the icon. For example, display screen 106 may include a separate ‘Search’ icon corresponding to an instruction to perform a search based on the positioning of the search space icon(s). When the user selects the ‘Search’ icon, display screen driver 206 converts this selection to an instruction to perform a search based on the positioning of the search space icon(s), and in response to the instruction, search engine 208 generates (318) a search query based on the position(s) of the icon(s) in the multi-dimensional search space. However, in another embodiment of the present invention, the user of user terminal 102 then may instruct the user terminal to perform a database search by individually selecting a particular icon in the multi-dimensional search space, thereby instructing user terminal 102 to generate a search query based on the position of that particular icon(s) in the multi-dimensional graph.

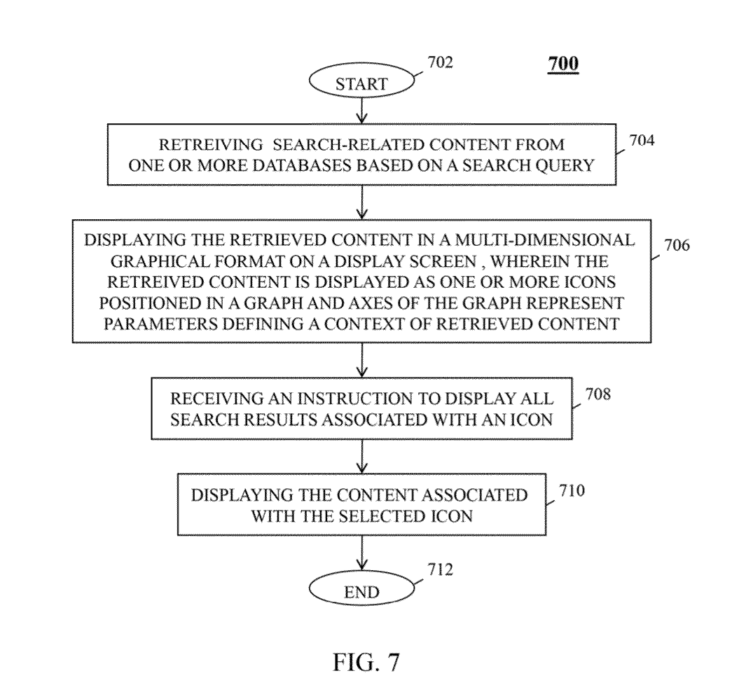

User terminal 102, and in particular user query converter 208, then executes a search (320), via one or more of search engines 140-142, of one or more of the multiple databases 120-132 based on the search query, and downloads (322) the results of the search, that is, search-related content, to user terminal 102. User terminal 102 then may display (324) the search results in a multi-dimensional graphical format, as described in greater detail with respect to FIG. 7, and logic flow diagram 300 then ends (326).

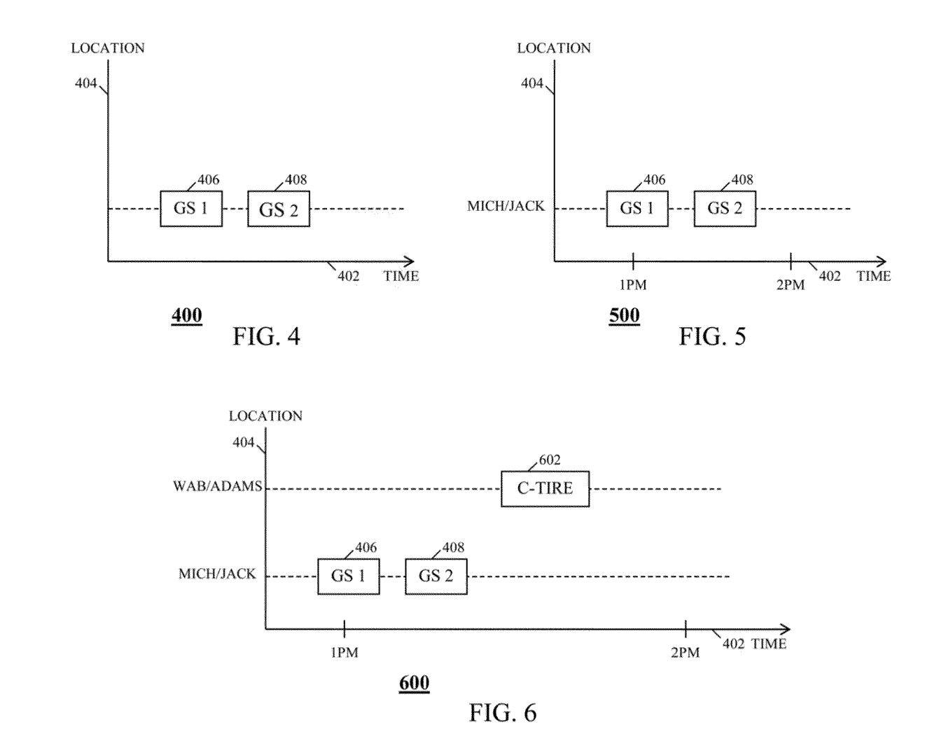

For example, and referring now to FIG. 4, an exemplary multi-dimensional graphical representation 400 of a search query that may be displayed on display screen 106 is illustrated in accordance with an embodiment of the present invention. As depicted in FIG. 4, multi-dimensional graphical representation 400 comprises a two-dimensional graph, wherein a first, horizontal axis 402 of the graph represents a first parameter, ‘time,’ and a second, vertical axis 404 of the graph represents a second parameter, ‘location.’ By positioning a multi-dimensional icon, such as icons 406 and 408, in graph 400, the user may input an instruction into user terminal 102 to search for an event occurring at a location and time corresponding to the positions of the icons in the graph. Further, the user may input into each icon one or more keywords and associated keyword modifiers to be searched and multimedia content or files that to provide additional search parameters—again, which multimedia content/files can be indexed to facilitate the search.

For example, in FIG. 4, a first multi-dimensional icon 406 and a second multi-dimensional icon 408 are each positioned at approximately a same position along vertical, that is, location, axis 404. However, icon 408 is positioned to the right of icon 406 along horizontal, or time, axis 402, indicating that in the search query, content, such as an event, associated with icon 408 occurs later in time than content associated with icon 406. In other words, a position of second multi-dimensional icon 408 relative to the first multi-dimensional icon 406 corresponds, with respect to a parameter (time) of the multiple parameters (time and location), to a value of the parameter associated with the second multi-dimensional icon relative to a value of the parameter associated with the first multi-dimensional icon.

Further, as depicted in FIG. 4, the user input a keyword ‘Gunshot’ (GS), along with an associated keyword modifier ‘1,’ (that is, one gunshot) into first icon 406 and the keyword ‘Gunshot’ (GS), along with an associated keyword modifier ‘2,’ (that is, two gunshots) into second icon 408. These icons may be boxes provided to the user by user terminal 102 via display screen 106, for example via a pull-down menu, which boxes can be filled with text by the user. The user also may appropriately size the icon to indicate features of a search query, for example, to depict a possible range of one of the multi-dimensional parameters. Thus, the positioning (and size) of icons 406 and 408 in FIG. 4, along with the associated text, causes user terminal 102 to generate a search query “all sequences of one gunshot followed (in time) by two gunshots happening at a same location.”

Referring now to FIGS. 5 and 6, exemplary multi-dimensional graphical representations 500, 600 of search queries that may be displayed on display screen 106 are illustrated in accordance with other embodiments of the present invention. More specifically, FIGS. 5 and 6 depict multi-dimensional graphical representations of search queries wherein the user further specifies specific values, or instances, of each dimensional parameter (that is, the parameters corresponding to each axis of the graphical representation) by specifically labeling discrete values of the axes.

That is, similar to FIG. 4, FIGS. 5 and 6 each depicts a multi-dimensional graph that may be displayed on display screen 106, wherein a first, horizontal axis 402 of the graph represents a first parameter, ‘time,’ and a second, vertical axis 404 of the graph represents a second parameter, ‘location.’ Further, similar to FIG. 4, in each of FIGS. 5 and 6, a first icon 406 and a second icon 408 are each positioned at approximately a same position along vertical, that is, location, axis 404, but second icon 408 is positioned to the right of first icon 406 along the horizontal, or time, axis. Again, the user input the keyword ‘Gunshot’ (GS), along with an associated keyword modifier ‘1,’ (that is, one gunshot) into first icon 406 and the keyword ‘Gunshot’ (GS), along with an associated keyword modifier ‘2,’ (that is, two gunshots) into second icon 408.

However, in FIG. 5, in the user also has input a discrete value for the ‘location’ parameter corresponding to the position of icons 406 and 408 along vertical axis 404. In particular, the user has assigned the value “Michigan/Jackson” (MICH/JACK) to the position of icons 406 and 408 along the vertical axis, corresponding to an intersection of Michigan Avenue and Jackson Boulevard. However, each discrete value assigned to the ‘location’ axis can be any one or combination of location parameters that may be used to define an event, such as one discrete location being a jewelry store and another discrete location being a pub, each discrete location being a specific retail establishment (for example, a particular coffee shop), or each discrete location being a street intersection, a city, or a Global Positioning Satellite (GPS) coordinate. Further, as depicted in FIG. 5, the user has input multiple discrete values for the ‘time’ parameter of horizontal axis 402, that is, assigning a value ‘1 pm’ to the position of icon 406 along the horizontal axis and assigning a value ‘2 pm’ to the right of icon 408 along the horizontal axis.

Thus, when the user instructs user terminal 102 to generate a search query based on the positioning of icons 406 and 408 in FIG. 5, along with the text input into the icons, and further based on the values/keywords assigned to the icons' positions along the horizontal and vertical axes, user terminal 102 may generate a search query “all sequences of one gunshot occurring around 1 pm at the intersection of Michigan Avenue and Jackson Boulevard, followed shortly (less than an hour) thereafter by two gunshots at the intersection of Michigan Avenue and Jackson Boulevard.”

Referring now to FIG. 6, multi-dimensional representation 600 is identical to multi-dimensional representation 500 except that the user has added a third icon 602 to the multi-dimensional representation, which third icon represents an event that occurs at a different location and time than icons 406 and 408. More particularly, the user has assigned the value “Wabash/Adams” (WAB/ADAMS) to the position of icon 602 along vertical axis 404, corresponding to an intersection of Wabash Avenue and Adams Street. Further, the user has positioned icon 602 to the right, of icons 406 and 408 along horizontal axis 402, but prior to the horizontal axis value of ‘2 pm’, indicating that the event represented by icon 602 occurs subsequent, in time, to the events corresponding to icons 406 and 408 but still prior to 2 pm. In addition, the user has input the keyword ‘Car Tire Screech’ (C-TIRE) into icon 602.

Thus, when the user instructs user terminal 102 to generate a search query based on the positioning of icons 406, 408, and 602 in FIG. 6, along with the text input into the icons, and further based on the values/keywords assigned to the icons' positions along the horizontal and vertical axes, user terminal 102 may generate a search query “all sequences of one gunshot occurring around 1 pm at the intersection of Michigan Avenue and Jackson Boulevard, followed shortly (less than an hour) thereafter by two gunshots at the intersection of Michigan Avenue and Jackson Boulevard, followed shortly thereafter by a car tire screeching at the intersection of Wabash Avenue and Adams Street.”

In other embodiments of the present invention, the user may individually select a particular icon in the multi-dimensional graph, such as individually selecting one of icons 406, 408, and 602, thereby instructing user terminal 102 to generate a search query based on the positioning of that particular icon(s) in the multi-dimensional graph.

Referring now to FIG. 7, a logic flow diagram 700 is provided that illustrates a method performed by user terminal 102 in graphically displaying search results in accordance with an embodiment of the present invention. Logic flow 700 begins (702) when, in response to receiving an instruction to perform a search, user terminal 102, and in particular user query converter 208, and based on a user terminal-generated search query, retrieves (704), via one or more of search engines 140-142, search-related content stored at one or more of the multiple databases 130-132. User terminal 102, and in particular user query converter 208, then converts the text to graphical information and displays (706), via display screen driver 206, the retrieved content in a multi-dimensional graphical format on display screen 106, wherein the retrieved content is displayed as one or more icons positioned in a graph, and wherein the axes of the graph represent parameters defining a context of the retrieved content. For example, the retrieved content may be various media and multimedia content, such as video, audio recordings, email, tweets, and other social media associated with an occurrence of an event, and the axes of the graph may represent parameters defining the occurrence of the event, for example, time and location.

The user of user terminal 102 then may select an icon, in response to which display driver 206 generates an instruction (708) to display all search results, that is, content, associated with that icon/event. In response to receiving the instruction, user terminal displays (710) the content associated with the selected icon, and logic flow diagram 700 ends (712).

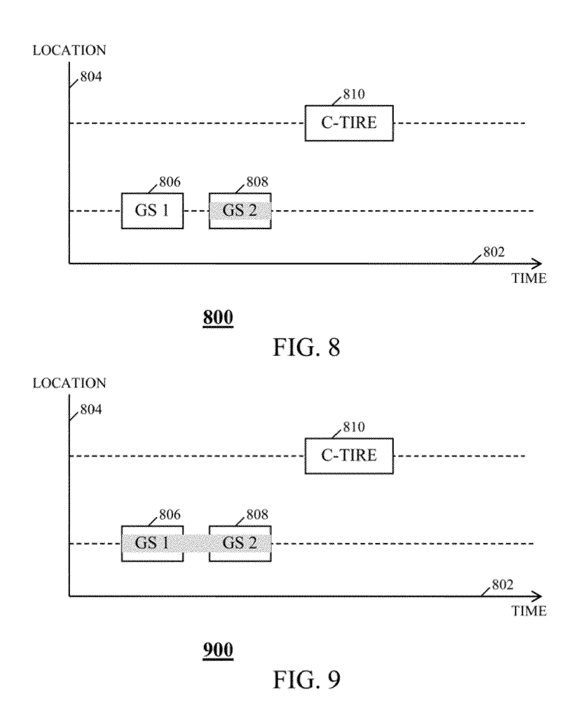

For example, and referring now to FIG. 8, an exemplary multi-dimensional graphical representation 800 of the results of a search query is illustrated, which multi-dimensional graphical representation may be displayed on display screen 106 in accordance with an embodiment of the present invention. More particularly, multi-dimensional graphical representation 800 is an exemplary graphical representation of results of the search query depicted in FIG. 6. Similar to FIG. 6, multi-dimensional graphical representation 800 comprises a two-dimensional graph, wherein a first, horizontal axis 802 of the graph represents a first event defining parameter, ‘time,’ and a second, vertical axis 804 of the graph represents a second event defining parameter, ‘location.’ Icons 806, 808, and 810 represent the searched events, defined by keywords and, optionally, keyword modifiers and multimedia content or files.

For example, in FIG. 8, a first icon 806 and a second icon 808 are each positioned at approximately a same position along vertical, for example, location, axis 804. Thus it may be inferred that a first event defining parameter, location, is the same for each of the events represented by icons 806 and 808. However, a third icon 810 is positioned at a different position along vertical axis 804 than icons 806 and 808. Thus it may be inferred that the first event defining parameter, location, is different for the event represented by icon 810 than for the events represented by icons 806 and 808.

Further, each of icons 806, 808, and 810 is positioned at a different position along horizontal, for example, time, axis 802. Thus it may be inferred that a second event defining parameter, time, is different for each of the events represented by icons 806, 808, and 810, and further that an event represented by icon 808 occurred later in time than an event represented by icon 806, and that an event represented by icon 810 occurred later in time than the event represented by icon 808.

In addition, each icon includes text corresponding to keywords, and optionally keyword modifiers, searched with respect to the corresponding event. For example, icon 806 includes the text ‘GS 1,’ corresponding to the keyword ‘Gunshot’ (GS) and the keyword modifier ‘1’ (that is, one gunshot). Similarly, icon 808 includes the text ‘GS 2,’ corresponding to the keyword ‘Gunshot’ (GS) and the keyword modifier ‘2’ (that is, two gunshots). And icon 810 includes the text ‘C-TIRE,’ corresponding to the keywords ‘Car Tire Screech.’

User terminal 102 then may display the retrieved content by indicating, in multi-dimensional graphical representation 800, which of events have been found in the search. For example, user terminal 102 may highlight an icon to indicate that content associated with the event corresponding to that icon has been found. For example, in multi-dimensional graphical representation 800, icon 808, is highlighted (by shading). This may be interpreted to mean that “media content was found that meets at least one parameter of the ‘two gunshots’ query.” For example, a video with two consecutive gunshots may have been found and/or a tweet noting the occurrence of two consecutive gunshots may have been found. The user of user terminal 102 then may select the highlighted icon, that is, icon 808, to instruct the user terminal to display all search results, that is, content, associated with that icon/event, such as all video recordings, audio recordings, emails, tweets, and/or any other social media associated with that event, such as Facebook© entries. The search results, that is, the retrieved content, then is displayed by user terminal 102 on display screen 106, for example, in a list, and the user then may select particular content to view by inputting a selection of an item in the list.

Referring now to FIG. 9, an exemplary multi-dimensional graphical representation 900 of the results of a search query is illustrated, which multi-dimensional graphical representation may be displayed on display screen 106 in accordance with another embodiment of the present invention. The multi-dimensional graphical representation 900 depicted in FIG. 9 is identical to multi-dimensional graphical representation 800 depicted in FIG. 8, except that both icons 806 and 808 are highlighted (shaded). This may be interpreted to mean that “media content was found that meets at least one term of the ‘one gunshot’ query and that meets at least one term of the ‘two gunshots’ query.”

For example, the search may have produced a tweet of someone mentioning a gunshot at Michigan Avenue, and a few minutes later the same person tweeting about two gunshots at Michigan Avenue. Or the search may have produced an audio recording where one gunshot is followed a few minutes later by two gunshots, where the location is unknown. The user of user terminal 102 then may select the highlighting stripe 812 to instruct the user terminal to display all search results. Again, the retrieved content may be presented by user terminal 102 on display screen 106 in a list that is ordered based on the number and the importance of parameters/keywords/keyword modifiers/multimedia content or files met by the content, with content meeting a larger number and importance of the parameters/keywords/keyword modifiers/multimedia content or files associated with the event (for example, content wherein the one gunshot and the following two gunshots are indicated to be close in time and at a same location) being positioned higher in the list.

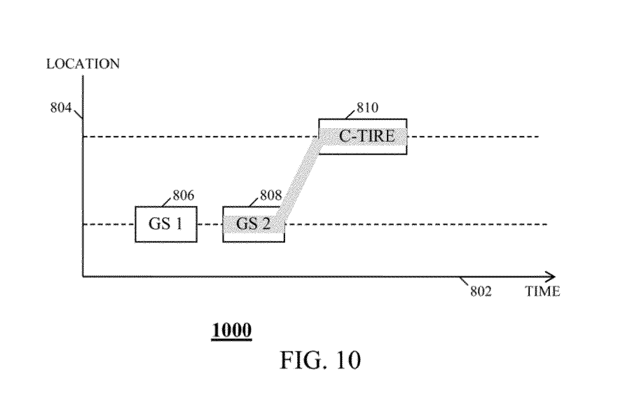

Referring now to FIG. 10, an exemplary multi-dimensional graphical representation 1000 of the results of a search query is illustrated, which multi-dimensional graphical representation may be displayed on display screen 106 in accordance with yet another embodiment of the present invention. The multi-dimensional graphical representation 1000 depicted in FIG. 10 is identical to multi-dimensional graphical representations 800 depicted in FIGS. 8 and 900 depicted in FIG. 9, except that icons 808 and 810 are highlighted (shaded). This may be interpreted to mean that “media content was found that meets at least one term of the ‘two gunshots’ query and that meets at least one term of the ‘car tire screech’ query.”

For example, suppose someone heard a gunshot at the intersection of Michigan Avenue and Jackson Boulevard and then pulled out his or her camera phone to record events. The person then recorded video that includes the sound of two more gunshots and that further depicts a person running away from an apparent location of the gunshots, getting in a car on Adams Street, and speeding away. Or perhaps, instead of actually recording video of the person getting in the car and driving away, the person just recorded the sound of the car screeching. Further, suppose the person recording the event then uploaded the video to a social media website, such as Facebook©. Such videos would meet all, or nearly all, of the search parameters/keywords/keyword modifiers associated with icons 808 and 810, and accordingly would be retrieved by search engine 108 and positioned near the top of a list of search results.

Further, and referring now to FIGS. 7 and 10, the content found may be used to search for additional media content. For example, suppose that the media retrieved in response to the search query is associated with other keywords not yet searched for. The user of user terminal 102 then may enhance the multi-dimensional graphical search query used to generate the search results by adding a new icon comprising text associated with the new keyword, and also can broaden a search by removing icons.

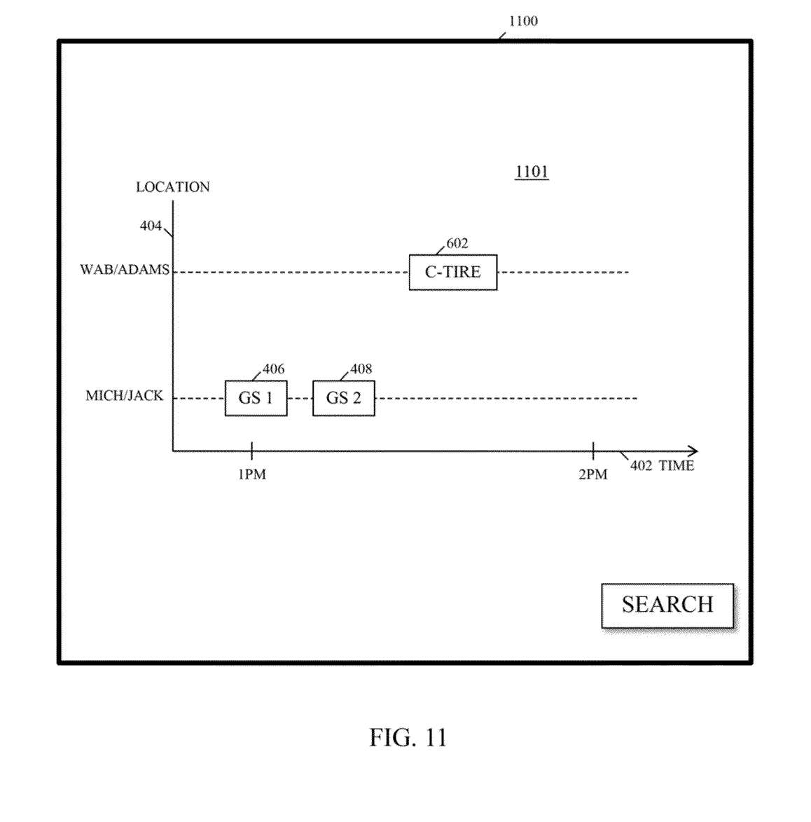

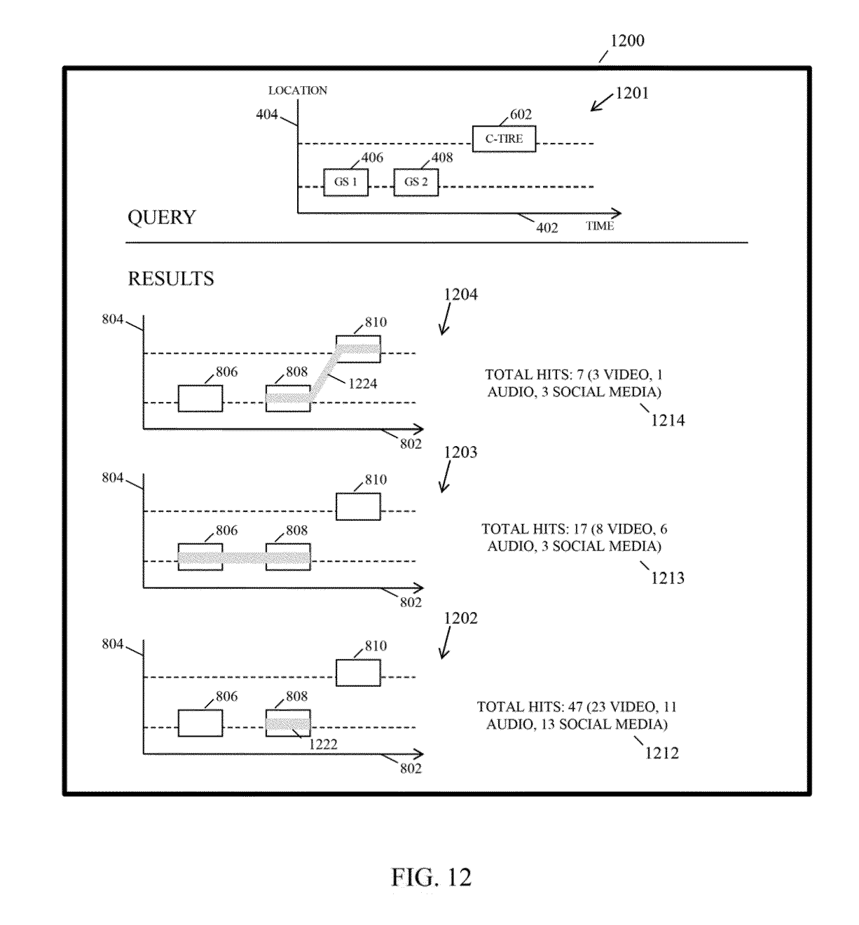

Referring now to FIGS. 11 and 12, exemplary diagrams 1100 and 1200 are provided that illustrate a graphical representation of a search query and corresponding search results that are concurrently displayed on display screen 106 in accordance with an embodiment of the present invention. More particularly, diagram 1100 illustrates a ‘query screen’ that includes an exemplary graphical representation 1101 of the search query and diagram 1200 illustrates a ‘results screen’ that depicts the search query 1101 accompanied one or more exemplary graphical representations 1202-1204 (three shown) of the search results. For example, graphical representation 1101 of the search query corresponds to the graphical representation of a search query illustrated in FIG. 6, and graphical representations 1202-1204 of the search results corresponds to the graphical representations of search results illustrated in FIGS. 8-10. In addition, diagram 1200 further provides a textual summary 1212-1214 of each depicted search result 1202-1204. Again, similar to FIGS. 8-10, the user may select particular content to view by inputting a selection of a particular highlighted icon of FIGS. 8-10, in response to which the user terminal generates an instruction for the display of, and responsively displays on display screen 106, all search results, that is, content, associated with that icon/event, such as a list of all video recordings, audio recordings, emails, tweets, and/or any other social media associated with that event, such as Facebook© entries. As depicted in the results screen, the results are represented in a similar manner as the query so that the user can understand the results immediately. Also, the results may be ranked on the screen based on how many terms of the original query are met in a single multimedia; for example a video from result 1204 that would contain both events 808 and 810, as indicated by 1224, would be more valuable than video that would contain only one event 808, such as in the result 1222.

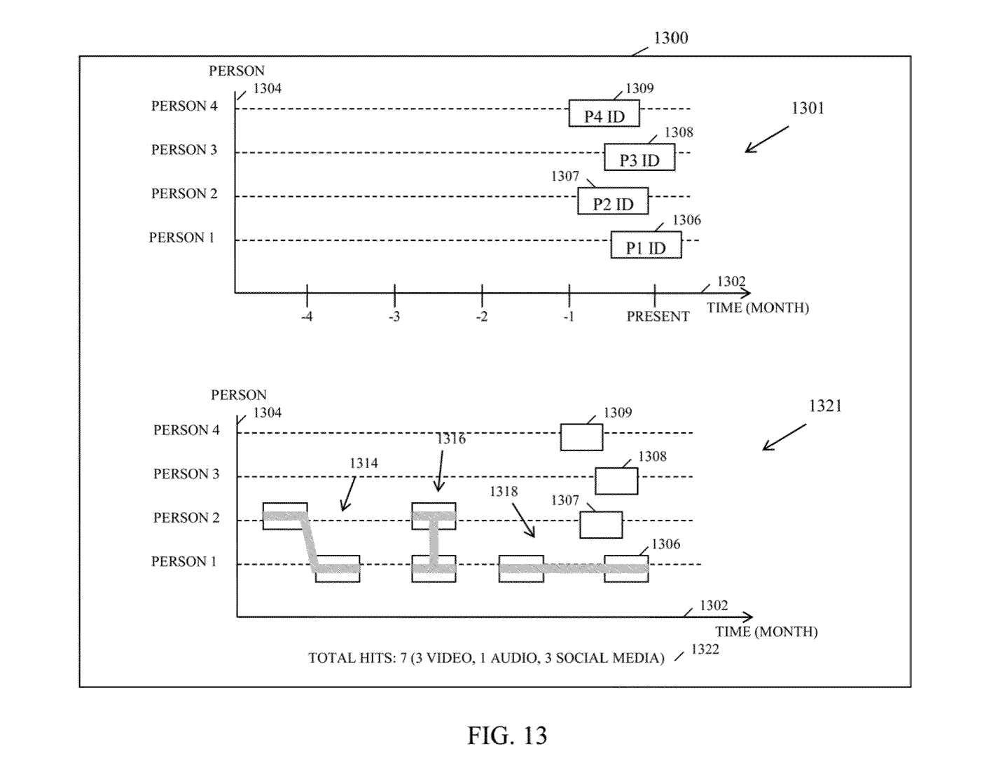

FIG. 13 is an exemplary diagram 1300 illustrating a graphical representation 1301 of a search query and a graphical representation 1321 of corresponding search results that that may be concurrently displayed on display screen 106, similarly to FIG. 12, in accordance with another embodiment of the present invention. For illustrative purposes, graphical representation 1301 depicts another content-defining parameter, that is, ‘person’ on the vertical axis, and again depicts ‘time’ on the horizontal axis, that may be employed to graphically define a search query. In the exemplary search query depicted in FIG. 13, ‘location’ is not one of the searched parameters. For example, the search may query media recorded by embassy cameras or retail store cameras, and Persons 1, 2, 3, and 4 may be identified by facial identification techniques. Second, also for exemplary purposes, graphical representation 1321 depicts how multiple different search results may be graphically displayed in a same graph, wherein some of the content found meets some of, but not all of, the searched parameters/keywords, keyword modifiers. For example, a possible scenario depicted in FIG. 13 could be one where all one has available are videos of four suspicious persons, and but the persons' identities may be unknown. Videos are uploaded into the icons “P1 ID” through “P4 ID.” User terminal 102 then executes an indexing algorithm on the videos. For example, the indexing algorithm may detect a face in the video, calculate facial features for the face, and include these features into the final machine readable query for search.

More particularly, graphical representation 1301 comprises four icons 1306-1309 that each represents a person who is searched. For example, icon 1306 includes a keyword identifying a ‘Person 1’ (P1 ID), icon 1307 includes a keyword identifying a ‘Person 2’ (P2 ID), icon 1308 includes a keyword identifying a ‘Person 3’ (P3 ID), and icon 1309 includes a keyword identifying a ‘Person 4’ (P4 ID). Further, icons 1306-1309 are approximately aligned in time (along the horizontal axis), indicating that a parameter of the search query is content that includes one or more of these persons and which content is of approximately of the same time (which searched time is the “present” time).

Graphical representation 1321, displaying the search results, also depicts the content-defining parameters, that is, “person” on the vertical axis and again “time” on the horizontal axis, and the events searched (icons 1306-1309). However, graphical representation 1321 further displays, via an icon-based representation, the search results, again by highlighting icons to indicate that content associated with the event corresponding to that icon has been found. For example, highlighted icon combination 1314 may indicate that the search produced media, or content, placing Persons 1 and 2 (corresponding to icons 1306 and 1307) at a same location but at different times. By way of another example, highlighted icon combination 1316 may indicate that the search produced media, or content, placing Persons 1 and 2 (again, corresponding to icons 1306 and 1307) at a same location at approximately a same time. By way of yet another example, highlighted icon combination 1318 may indicate that the search produced media, or content, placing Person 1 (corresponding to icon 1306) at a same location at two different times. And further, graphical representation 1321 includes a textual summary 1322 of the depicted search results.

Again, user may select particular content to view by inputting a selection of a particular highlighting stripe, in response to which user terminal 102 generates an instruction for the display of, and responsively displays on display screen 106, all search results, that is, content, associated with that highlighting stripe, such as a list of all video recordings or audio recordings associated with that highlighting stripe.

As described above, a method and apparatus are provided for presenting search queries and results in a multi-dimensional graphical representation. The axes of the graph may be any content-defining parameters sought to be searched, for example, any parameters that may be used to define an event that is being searched. While examples herein disclose the parameters time, location, and persons, any other event-defining parameter may be used that may occur to one who wishes to perform a database search. Further, while the examples herein disclose a two-dimensional search space, this is not meant to limit the invention as additional dimensions may be searched, for example, time, location, and persons. Further, as indicated, the values assigned to the content-defining parameters (the axes of a search space) need not be proximate to each other; for example, various values along a ‘location’ axis may be cities, such as ‘Chicago’ and ‘Paris,’ or various values along a ‘time’ axis may be hours, days, months, or years.

The search results depicted in FIG. 13 depict relationships among the events (in this instance, persons) searched, and more particularly among icons 1306-1309 corresponding to each event searched, in two different ways. A first way of depicting a relationship among icons happens in an implicit way; it is when two or more icons on the multidimensional graph are horizontally or vertically “aligned.” For example, the placement of icon combination 1316 in the graphical representation 1321 of the search results in FIG. 13 indicates the corresponding events are related because they occurred at the same time (vertical alignment). In another example, the placement of icon combination 1318 in the graphical representation 1321 of the search results in FIG. 13 also indicates relationship with the original icon 1306, where the two events are related because they involve the same person P1. The second way of depicting the relationship is done explicitly by placing highlighting stripes on the icons of the related events. Using the same example of the icon combination 1318, in addition to the implicitly depicted relationship between the two events of involving the same person P1, a second relationship is indicated explicitly by the highlighting stripe. The type of relationship is revealed together with the found multimedia content when user selects the particular highlighting stripe. For example, in the case of icon combination 1318, the icons/events may be related because of the found multimedia content being recorded at the same location, which may be an embassy in this particular case.

Thus, the multi-dimensional graphical representation may display any kind of relationship of interest. Further, the graphical query may set out a parameter range, rather than merely specifying specific instances of a parameter. For example, in another embodiment of the present invention, graphical representation 1301 may correspond to a search query “find all media from the past 4 months (‘present’ to ‘−4’ months) that includes any of these four people and display any relationship that is detected among them.”

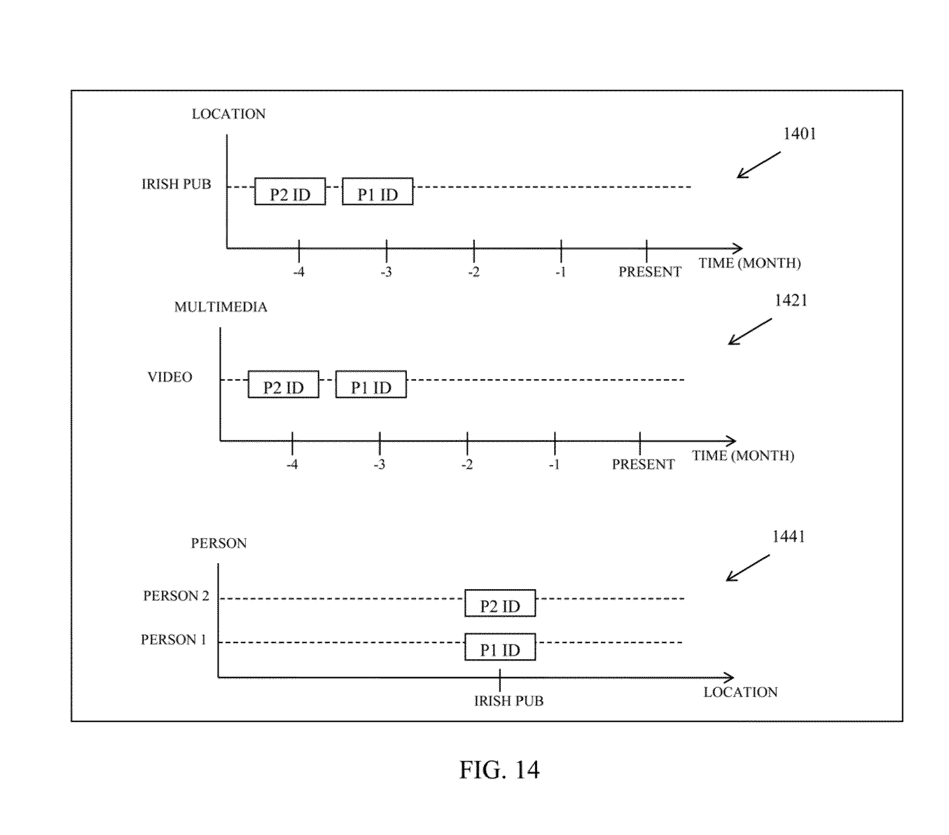

Further, when the user selects a highlighting stripe, the relationship can also be revealed graphically. For example, the highlighting stripe 1314 in FIG. 13 shows explicitly a relationship between Person 1 and Person 2. After user selects highlighting stripe 1314, this relationship can be revealed in an implicit way as depicted in graphical representations 1401 and 1421 of query results depicted in FIG. 14. Graphical representation 1401 indicates that Person 1 and Person 2 are related, and the corresponding icons are horizontally aligned, in the sense that they were identified in the found multimedia content from the same location, for example, an Irish Pub. Similarly, graphical representation 1421 of FIG. 14 shows the same two persons are related because they have been identified on a same continuous footage of video. As another example, the explicit relationship 1316 in FIG. 13, indicated by highlighting stripe 1316, can be revealed in an implicit way when user selects 1316, and the results returned are depicted in graphical representation 1441 in FIG. 14. The two icons of graphical representation 1441 are vertically aligned, which indicates that the persons are related due to the found multimedia content being from the same location.

A user then may review, for example, view or listen to, the retrieved media by selecting an icon in a graphical representation of the search results, thereby instructing user terminal 102 to display all media, for example, a list of retrieved media, associated with that icon.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for graphically formulating a search query, the method comprising:
displaying a multi-dimensional graphical representation of a search query space;
receiving a plurality of parameters from a user, wherein the parameters define the search query space;
positioning and sizing a multi-dimensional icon in the multi-dimensional representation of the search query space;
associating one or more of a keyword and multimedia content with the icon; and
generating a search query based on the one or more of the keyword and multimedia content, and the position and size of the icon in the multi-dimensional representation of the search query space.

2. The method of claim 1, further comprising, in association with the keyword, associating a keyword modifier with the icon.

3. The method of claim 1, wherein the multi-dimensional graphical representation of the search query space comprises a multi-dimensional graph having a plurality of axes, and wherein the method further comprises associating each axis of the plurality of axes with a parameter of the plurality of parameters.

4. The method of claim 3, further comprising receiving one or more values associated with a parameter of the plurality of parameters, wherein each value of the one or more values corresponds to a position along the axis associated with the parameter.

5. The method of claim 4, further comprising adjusting a position and size of the multi-dimensional icon in the multi-dimensional representation of the search query space to change a value of a parameter, of the plurality of parameters, associated with the icon.

6. The method of claim 1, wherein associating a keyword with the icon comprises receiving a keyword from the user and associating the received keyword with the icon.

7. The method of claim 6, wherein receiving a keyword from the user comprises receiving an insertion of text, into the icon, from the user.

8. The method of claim 1, wherein associating a multimedia content with the icon comprises receiving a multimedia content from the user and associating the received multimedia content with the icon.

9. The method of claim 8, wherein receiving a multimedia content from the user comprises uploading a multimedia file, into the icon, by the user.

10. The method of claim 1, wherein generating a search query based on multimedia content involves indexing of the multimedia content.

11. The method of claim 1, wherein the multi-dimensional icon is a first multi-dimensional icon and further comprising positioning a second multi-dimensional icon in the multi-dimensional representation of the search query space, wherein a position of the second multi-dimensional icon relative to the first multi-dimensional icon corresponds, with respect to a parameter of the plurality of parameters, to a value of the parameter associated with the second multi-dimensional icon relative to a value of the parameter associated with the first multi-dimensional icon.

12. The method of claim 1, further comprising:
searching one or more databases based on the search query; and
displaying results of the search in a multi-dimensional graphical format indicating relationships among the graphically formulated search query and search results.

13. The method of claim 12, wherein relationships among the graphically formulated search query and search results is shown by one or more of a horizontal alignment of multi-dimensional icons and a vertical alignment of multi-dimensional icons.

14. The method of claim 12, wherein relationships among the graphically formulated search query and search results is shown by adding an explicit graphical connection between one or more related multi-dimensional icons.

15. The method of claim 12, wherein the results of the search and the graphically formulated search query are displayed concurrently on the same display screen.

16. A method for graphically displaying results of a database search, the method comprising:
retrieving search-related multi-media content from one or more databases based on a search query; and
displaying the search results in a multi-dimensional graphical format on a display screen, wherein the retrieved multimedia content is displayed as one or more icons positioned in a multi-dimensional graph having a plurality of axes, wherein each axis of the plurality of axes is associated with a parameter of the plurality of parameters defining a context of the search query, and wherein relationships among search results are indicated.

17. The method of claim 16, wherein the relationships among search results are shown by one or more of a horizontal alignment of multi-dimensional icons and a vertical alignment of multi-dimensional icons.

18. The method of claim 16, wherein the relationships among search results are shown by adding an explicit graphical connection between one or more related multi-dimensional icons.

19. The method of claim 16 further comprising:
receiving, from a user, a selection of one or more of an icon and an explicit graphical connection; and
in response to receiving the selection of the one or more of the icon and the explicit graphical connection, displaying a list of multimedia content associated with the selected icon or explicit graphical connection.

20. A user terminal comprising:
a user interface comprising a display screen; and
a processor that is configured to:
display, via the display screen, a multi-dimensional graphical representation of a search query space;
receive, via the user interface, a plurality of parameters from a user, wherein the parameters define the search query space;
position and size a multi-dimensional icon in the multi-dimensional representation of the search query space;
associate one or more of a keyword and multimedia content with the icon; and
generate a search query based on the one or more of the keyword and multimedia content, and the position and size of the icon in the multi-dimensional representation of the search query space.

21. The user terminal of claim 20, wherein the processor further is configured to, in association with the keyword, associate a keyword modifier with the icon.

22. The user terminal of claim 20, wherein the multi-dimensional graphical representation of the search query space comprises a multi-dimensional graph having a plurality of axes, and wherein the processor further is configured to associate each axis of the plurality of axes with a parameter of the plurality of parameters.

23. The user terminal of claim 22, wherein the processor further is configured to receive one or more values associated with a parameter of the plurality of parameters, wherein each value of the one or more values corresponds to a position along the axis associated with the parameter.

24. The user terminal of claim 23, wherein the processor further is configured to, in response to an instruction from the user, adjust a position and size of the multi-dimensional icon in the multi-dimensional representation of the search query space to change a value of a parameter, of the plurality of parameters, associated with the icon.

25. The user terminal of claim 20, wherein the processor is configured to associate a keyword with the icon by receiving a keyword from the user and associating the received keyword with the icon.

26. The user terminal of claim 25, wherein the processor is configured to receive a keyword from the user by receiving an insertion of text, into the icon, from the user.

27. The user terminal of claim 20, wherein associating a multimedia content with the icon comprises receiving a multimedia content from the user and associating the received multimedia content with the icon.

28. The method of claim 27, wherein receiving a multimedia content from the user comprises uploading a multimedia file, into the icon, by the user.

29. The method of claim 20, wherein generating a search query based on multimedia content involves indexing of the multimedia content.

30. The user terminal of claim 20, wherein the multi-dimensional icon is a first multi-dimensional icon and wherein the processor further is configured to, in response to an instruction from the user, position a second multi-dimensional icon in the multi-dimensional representation of the search query space, wherein a position of the second multi-dimensional icon relative to the first multi-dimensional icon corresponds, with respect to a parameter of the plurality of parameters, to a value of the parameter associated with the second multi-dimensional icon relative to a value of the parameter associated with the first multi-dimensional icon.

31. The user terminal of claim 20, wherein the processor further is configured to perform a search of one or more databases based on the search query and display, via the display screen, results of the search in a multi-dimensional graphical format indicating relationships among the graphically formulated search query and search results.

32. The user terminal of claim 31, wherein relationships among the graphically formulated search query and search results is shown by one or more of a horizontal alignment of multi-dimensional icons and a vertical alignment of multi-dimensional icons.

33. The user terminal of claim 31, wherein relationships among the graphically formulated search query and search results is shown by adding an explicit graphical connection between one or more related multi-dimensional icons.

34. The user terminal of claim 31, wherein the results of the search and the graphically formulated search query are displayed concurrently on the same display screen.

35. A user terminal for graphically displaying results of a database search, the user terminal comprising:
a display screen;
a processor that is configured to:
retrieve search-related multi-media content from one or more databases based on a search query; and
display, via the display screen, the search results in a multi-dimensional graphical format on a display screen, wherein the retrieved multi-media content is displayed as one or more icons positioned in a multi-dimensional graph having a plurality of axes, wherein each axis of the plurality of axes is associated with a parameter of the plurality of parameters defining a context of the search query, and wherein a relationship among search results is indicated.

36. The method of claim 35, wherein the relationships among search results are shown by one or more of a horizontal alignment of multi-dimensional icons and a vertical alignment of multi-dimensional icons.

37. The method of claim 35, wherein the relationships among search results are shown by adding an explicit graphical connection between one or more related multi-dimensional icons.

38. The user terminal of claim 35, wherein the processor further is configured to:
receive, from a user, a selection of one or more of an icon and an explicit graphical connection; and
in response to receiving the selection of the one or more of the icon and the explicit graphical connection, display, via the display screen, a list of multimedia content associated with the selected icon or explicit graphical connection.
